(19) United States
(12) Patent Application Publication
(10) Pub. No.: US 2014/0101780 A1
(43) Pub. Date: Apr. 10, 2014

(54) Method for comment response request feeds to a social networking profile

(71) Applicant: Thomas F. Zuber, Los Angeles, CA (US)

(72) Inventor: Thomas F. Zuber, Los Angeles, CA (US)

(21) Appl. No.: 13/645,234

(22) Filed: Oct. 4, 2012

(51) Int. Cl. G06F 3/01; G06F 21/24

(52) U.S. Cl. 726/28; 715/753

(57) ABSTRACT

A method for adding comments to documents and billing items in the context of an online network. As the comments are created a message system within the network automatically sends a notification to the member or members of the online community to whom the comment is directed, showing them the comment and providing a live link to the associated document or billing item. Each comment is associated with a specific document or billing item, and can be customized to be directed to one or several users of the social network, and those users may also then create responses to the original comment using the same method.

### CROSS REFERENCE TO RELATED APPLICATIONS

This application claims benefit under 35 U.S.C. 119(e) to U.S. Provisional Patent Application Ser. No. 61/629,949, filed Nov. 30, 2011, entitled “Method for comment response request feeds to a social networking profile.” This application is related to commonly-owned U.S. patent application Ser. No. 12/493,096, filed Jun. 26, 2009, U.S. patent application Ser. No. 12/575,442, filed Oct. 7, 2009, U.S. patent application Ser. No. 12/493,096, filed Jun. 26, 2009, U.S. Provisional Patent Application No. 61/210,627, filed Mar. 20, 2009, U.S. patent application Ser. No. 12/885,325, filed Sep. 17, 2010, U.S. Provisional Patent Application No. 61/455,985, filed Oct. 29, 2010, U.S. patent application Ser. No. 13/011,655, filed Jan. 21, 2011, U.S. patent application Ser. No. 13/278,127, filed Oct. 20, 2011, U.S. patent application Ser. No. 13/324,980, filed Dec. 13, 2011, Provisional Patent Application No. 61/685,747, filed Mar. 22, 2012, and Provisional Patent Application No. 61/688,335, filed May 10, 2012. The contents of each of these patent applications are incorporated herein in their entirety by reference.

### STATEMENT REGARDING FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to methods for adding user comments to documents in a financial management tool, or a document management tool, in the context of a secure, online social networking community integrated with a billing tool, and a document management tool, enabled with multiple social networking functionalities, document management functionalities, billing functionalities, and integrative functionalities.

Social networking web sites, such as Facebook.com and MySpace.com, are communities of persons having virtual identities enabled with social networking functionalities. Such sites are often geared towards users having special recreational or social interests such as sports, hobbies or dating. There are also social networking web sites for professionals—for example, LinkedIn.com, EsqChat.com and LegallyMinded.com—and some of these sites are communities of persons having virtual identities enabled with social networking functionalities

The prior art discloses document management systems or (also known as document management tools), meaning systems or tools for managing, creating, editing, deleting, saving, organizing and accessing documents. For instance, Microsoft Office®, more particularly, its Word®, Excel®, and Power Point® applications, allow for creating, editing, deleting, saving and accessing of documents. Microsoft Office® also includes an Outlook® application that allows creating, editing, deleting, saving, accessing, sending and receiving emails. Another prior art system, Interwoven, offers a document management system that allows for organizing, storing and retrieving documents.

The preceding document management systems are generally examples of stand-alone document systems, most of which are only available as stand-alone systems that require a dedicated network and are not available online. Thus many systems offering document management systems are not available with the type of economies of scale obtainable when offered to a larger community online. Some systems provide some functionalities of a document management system in an online context. For instance, Google.com and OpenOffice.org offer applications for creating, editing, deleting, saving and accessing documents in an online context, and for creating, editing, deleting, saving, accessing, sending and receiving emails in an online context. For instance, HyperOffice.com offers an online document organization system for organizing, storing and retrieving documents online. Likewise, Mint.com offers an online financial management service for categorizing transactions, developing budgets, storing and retrieving personal data online. However, such document management and financial management systems that operate in an online context are not offered in the context of integration with a networking community made up of virtual identities enabling social networking functionalities, enhanced with the integrative functionalities described below.

Thus, the prior art lacks a means to allow a user to enable a single online virtual identity, via entry of a single username and password, that allows the user to manage both documents and financial records in a secure online database, where each database is shared by a different organization (or other group of users), and where each organization desires to keep documents and financial records confidential to the organization secure from and inaccessible by the other organizations as a whole or even from member in the organization who do not possess the appropriate security level clearance to access specific content. The prior art also lacks a means to fully integrate those documents and financial records with an organization's electronic communication system, as described below.

Thus there remains a need for a method and system which effectively combines or integrates these online business tools such as document management systems, and financial management tools, and which allows users to share documents and financial management tool items (The term “financial management tool item” is defined herein as a billing record, an accounting record, an invoice or a draft invoice in the financial management tool. The terms “financial management tool item” and “financial record” may be used interchangeably.) and collaborate on work product within a secure networking community. Furthermore, the present invention allows a first user to open a document in the document management system or a billing item in the financial management tool, add a comment to the item, and have an automatic notification sent to another user, or users, alerting them of the comment added to the item by the first user. The entire process is executed in the context of a dedicated secure social network environment. Through this integration of these separate systems or tools, the social network user is able to more quickly and efficiently communicate with other users, as such integrated comment fields and automatic notification eliminates the need for attaching documents to emails and then sending such emails with attachments through a separate email application.

There is a need for a more efficient means of communication among collaborators in an organization or association, namely, a means of communication that eliminates the multi-step process of collaborating through email. For example, currently if any user is reviewing a draft invoice in an invoicing application of a financial management tool, and needs information from another member regarding an entry on an invoice, how does the first user more efficiently deliver a copy of the draft statement, and a pertinent question or questions to the second user? Using email the first user must leave the invoicing application, open an email application, open a new email window, locate and enter the second user's email address, enter a subject line, compose a question in the body of an email, then create an attachment by searching through their files for the invoice which is referenced in the question, and attach the pertinent invoice to the email.

The present invention eliminates this multi-step multi-application process by allowing questions and comments to be created and attached directly to the documents and financial records they reference, and transmitted to other specific and intended users in a deliberate manner from within a single application, as securely and privately as desired. This commenting tool is integrated within the document management system, and the financial management tool, so that members within the network may easily and more efficiently communicate and collaborate.

### BRIEF SUMMARY OF THE INVENTION

The present invention describes an integration of cloud computing-based services through a portal that combines social networking functionalities with document management tools (such as are described in patent application Ser. No. 12/575,442 incorporated by reference herein), and billing, accounting and invoicing tools, further enhanced with integrative functionalities as described herein.

The present invention discloses a secure, network-based collaborative work environment in which one or more members of an online community having virtual identities enabled with a plurality of social networking functionalities, document management functionalities, and billing, accounting and invoicing functionalities. A commenting tool is integrated into the social network environment such that users' comments can be attached to documents within the document management system, and financial records within the financial management tool. The integrated functionalities of this commenting tool include, but are not limited to: allowing users to send messages to other users within the secure social network; allowing users to attach comments to pre-existing files in either the document management system or the financial management tool; allowing users to direct their comments to another user, a select number of users, or all the users who are members of the network, such that the comments are kept private and are accessible only by the users to whom they are directed; automatic generation of a notification which is sent to the indicated user, or users, alerting them of the comment sent by a first user; the automatic notification of the comment appears immediately on the social network home page of the user, or users, to whom the comment is directed; allowing users to open the notification of the comment from their social network home page which in turn immediately opens the document file in the document management system or the financial management tool, allowing the users to immediately see the item associated with the comment together and alongside the entire comment on the same screen; allowing users to reply to the comment; allowing users to direct their reply to another user, or other users, such that the reply is private and is accessible only by the users to whom the reply is directed; allowing users to open the notification of the reply from their social network home page which in turn immediately opens the relevant document in the document management system or relevant financial record in the financial management tool, allowing the users to immediately see the document or financial record together with the reply and an abbreviated record of past comments, if any exist, which themselves can be expanded to show a complete history of all prior comments in their entirety.

All of this is done in the context of the secure social network environment, as described more fully below.

### BRIEF DESCRIPTION OF THE DRAWINGS

FIG. 1 is a representation of a network member's home page screen on a graphical user interface from which a member may access document creation and editing programs within the document management system (also known as a Document Management Room, hereinafter referred to as “DMR”) and billing, accounting and invoicing applications within the financial management tool (also known as a Financial Management Room, hereinafter referred to as “FMR”), and all comments directed to the individual user (DMR Requests and FMR Requests).

FIG. 2 is a representation of a graphical user interface for the document management system accessible through the secure social network.

FIG. 3 is a representation of a graphical user interface for the financial management tool accessible through the secure social network.

FIG. 4 is a representation of a billing item in the financial management tool, and the commenting application selected to create a reply to a previous comment.

FIG. 5 is a representation of the DMR and the commenting tool as it would appear to the user that opens a comment notification from their home page.

FIG. 6 is a representation of the Document Management Room (“DMR”) Requests.

FIG. 7 is a representation of the Financial Management Room (“FMR”) Requests.

FIG. 8 is a representation of the Document Management Room (“DMR”), and the user designated color key which is used to define meanings for specific colors that are assigned to comment requests by users in the secure social network.

FIG. 9 is a representation of the Financial Management Room (“FMR”), and the user designated color key which is used to define meanings for specific colors that are assigned to comment requests by users in the secure social network.

FIG. 10 is a representation of the Document Management Room (“DMR”), and commenting application used to highlight text which is being commented on and reveal information regarding the commentator.

### DETAILED DESCRIPTION OF THE INVENTION

In the following description of the present invention reference is made to the accompanying drawings which form a part thereof, and in which is shown by way of illustration, exemplary embodiments illustrating the principles of the present invention and how it may be used. It is to be understood that other embodiments may be utilized to practice the present invention and structural and functional changes may be made thereto without departing from the scope of the present invention.

In a system described in U.S. patent application Ser. Nos. 12/575,442 and 12/493,096, both incorporated herein in their entirety by reference, a secure social networking community is described, where the members of the social networking community are professionals such as lawyers, accountants, doctors, bankers, teachers, artists, or any other type of person that provides services to others or collaborative groups for whom sharing ideas and data is essential, such as students.

It should be noted that the terms “profile” or “member profile” are used interchangeably and are each defined as the term “profile” is generally understood in the art, and can include a member's public pages or information visible to the public generally, information that is visible only to the member to whom the profile belongs, and information visible only to certain other invited members as specified by the member who owns the profile.

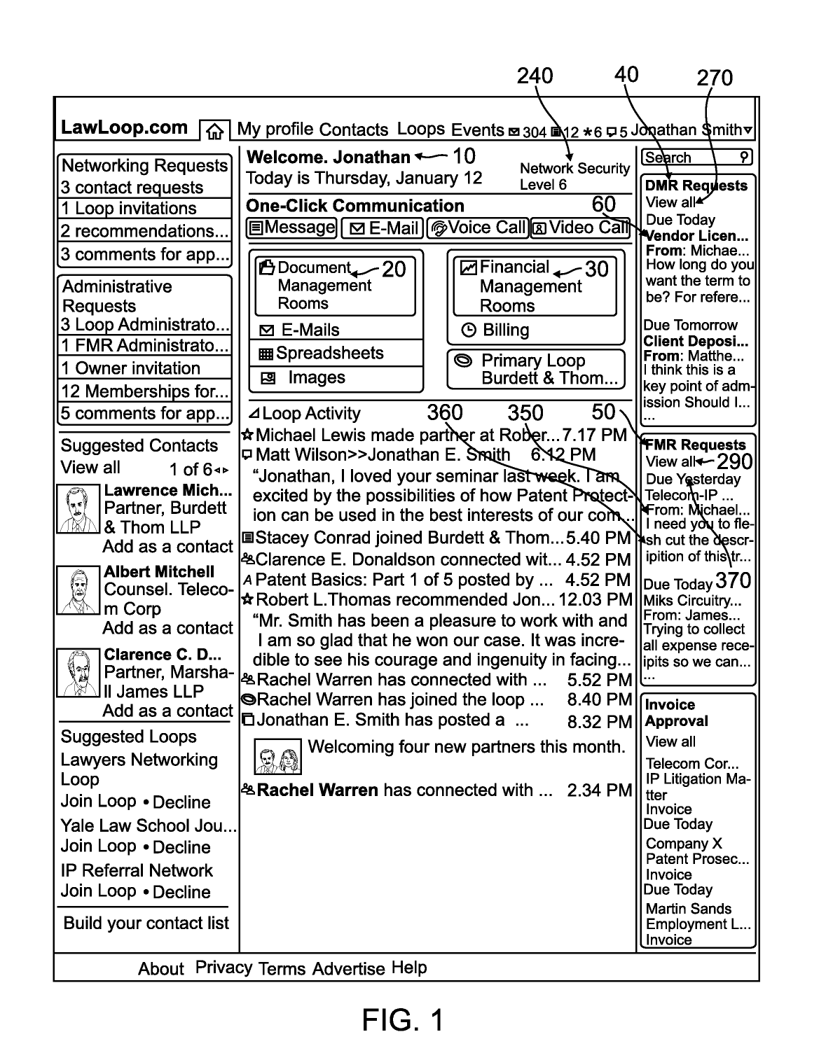

The term “home page” is defined as the term “home page” is generally understood in the art, and is the primary screen which is the first screen that is presented when a member logs into their profile (i.e.: by, for example, entering a username and password to log into their account) within the online social network (as shown in FIG. 1).

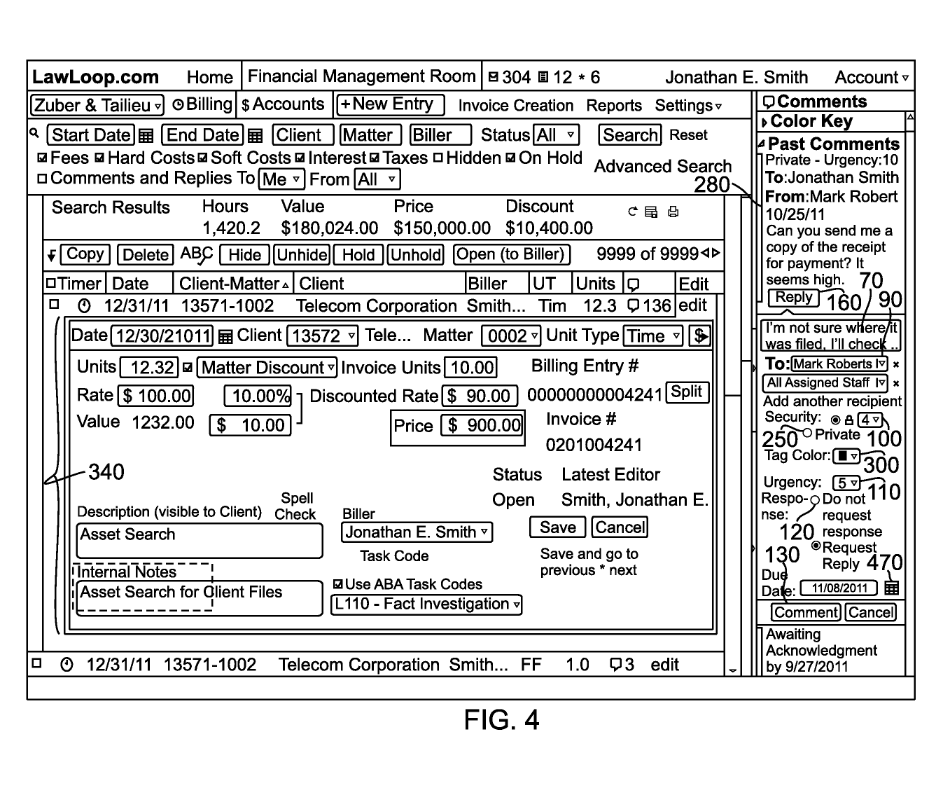

The term “billing item” or “billing application entry” is defined as a billing record, as such term is generally known in the art, like a transaction entry in Prolaw®, an instance of which could entail invoicing hours of work spent conducting an asset search for a client matter (as shown at 340 in FIG. 4).

The term “matter” is defined as it is commonly understood in the legal industry, a specific job being worked on for a client such as a lawsuit or a business deal, for example a litigation matter, or a transactional matter.

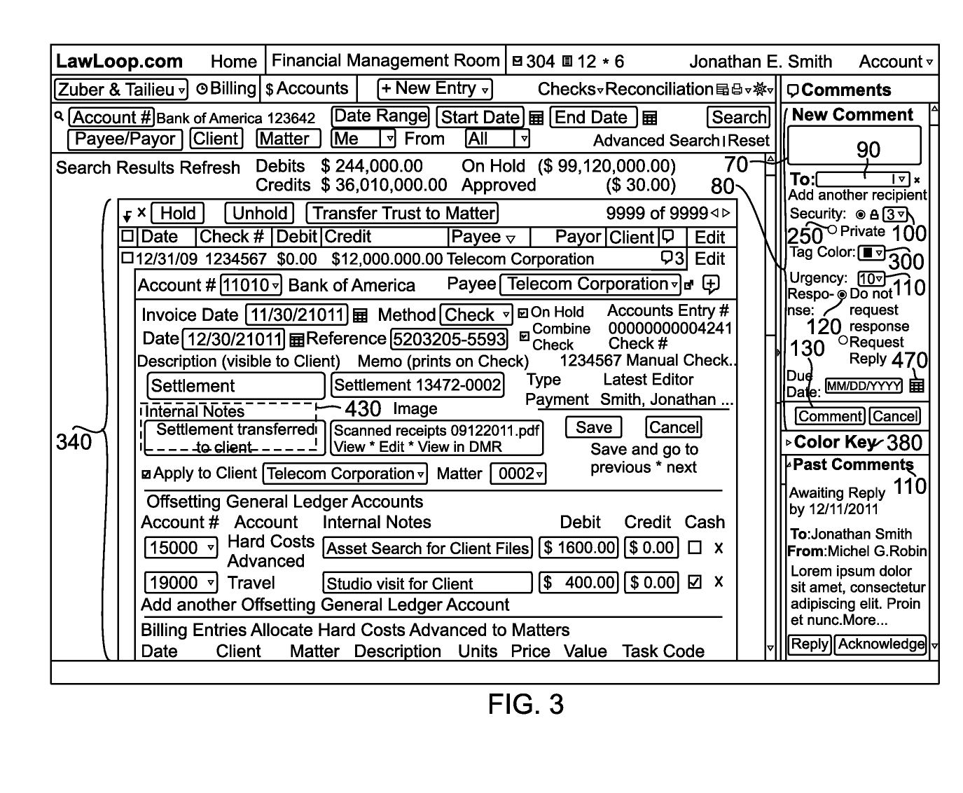

The term “accounting item” or “accounting application entry” is defined as an accounting record, as such term is generally known in the art, like a journal entry in Prolaw®, an instance of which could be a payment or deposit (as shown at 340 in FIG. 3).

Integrated in the secure social networking system is a document management system. This system is used by members of the network for creating, editing, deleting, saving, organizing and accessing documents.

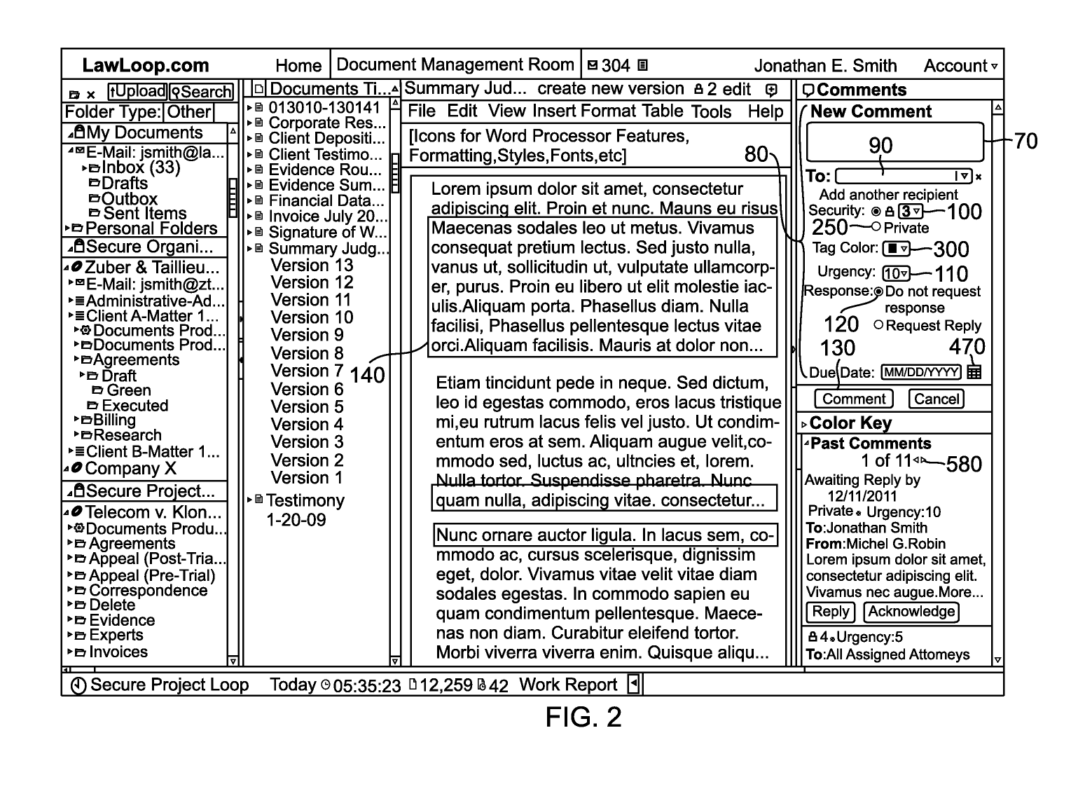

Integrated in the document management system is a commenting tool which appears on the screen as a sidebar when a document is opened in the document management system (as shown at 80 in FIG. 2). This commenting tool enables the members of the network to create a comment pertaining to a specific document in the document management system. This comment, once created, remains attached to the specific document with which it is associated. All comments are archived along with the respective document they are attached to in a Past Comments section which can be viewed in an abbreviated format when viewing the document or in full detail if the user clicks through to a dedicated comment archive screen. If more comments exist than can be viewed within the sidebar at any given time, the user may use forward and back buttons to cycle through pages of their past comments (as shown at 580 in FIG. 2). Using this tool, a member can create comments related to any document the member chooses to open in the document management system, such as a word processing document, chart, spreadsheet, presentation or an image file like a PDF, PNG, GIF, TIFF or JPG.

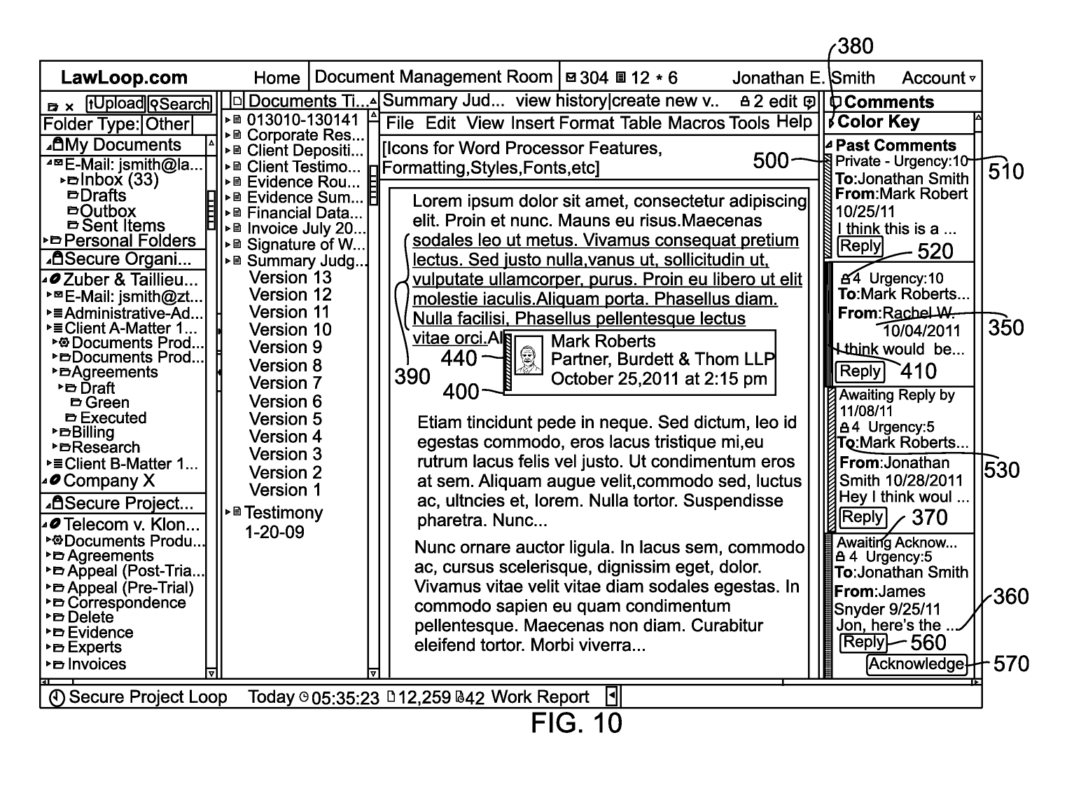

In the preferred embodiment a comment request consists of a due date, if one is assigned by the user (as shown at 370 in FIG. 10), a Private designation is listed if a comment has been set to be visible only to the recipient(s) by the sender (as shown at 500 in FIG. 10), an urgency designation if the sender has deemed to assign one (as shown at 510 in FIG. 10), a security level designation if the sender has deemed to assign one (as shown at 520 in FIG. 10), whom the comment is From which is the name of the user who sent the comment or who is replying to a prior comment request as well as when the comment request was posted (as shown at 350 in FIG. 10), the intended comment request recipient(s), or whom the comment is directed To, are listed (as shown at 530 in FIG. 10) and the text of comment itself (as shown at 360 in FIG. 10). Below the comment text the user has the option to Reply to the comment request (as shown at 560 in FIG. 10) or to Acknowledge receipt of the comment request (as shown at 570 in FIG. 10). The second user has the option to acknowledge a comment only if the first user chose to request acknowledgement of their comment request from the response options when composing their comment (as shown at 120 in FIG. 2). Lastly, the content of the comment is associated with a tag color, which the sender chose when composing their comment (as shown at 300 in FIG. 2), which is displayed alongside the length of the comment (as shown at 410 in FIG. 10).

The comment can be addressed to a second member of the network, and the second member will then receive a notification of the comment entered in the document management system via a feed (as the term “feed” is generally known in the art as a data format used for providing users with frequently updated content) to the home page of the second member's profile. In one embodiment the notification feed is rendered as a series of three notifications that relate to an item or items in the DMR (as shown at 40 in FIG. 1) and a series of three notifications that relate to an item or items in the FMR (as shown at 50 in FIG. 1). An alternative embodiment of the comment notification feed or feeds may vary in the number of notifications that are presented to the user.

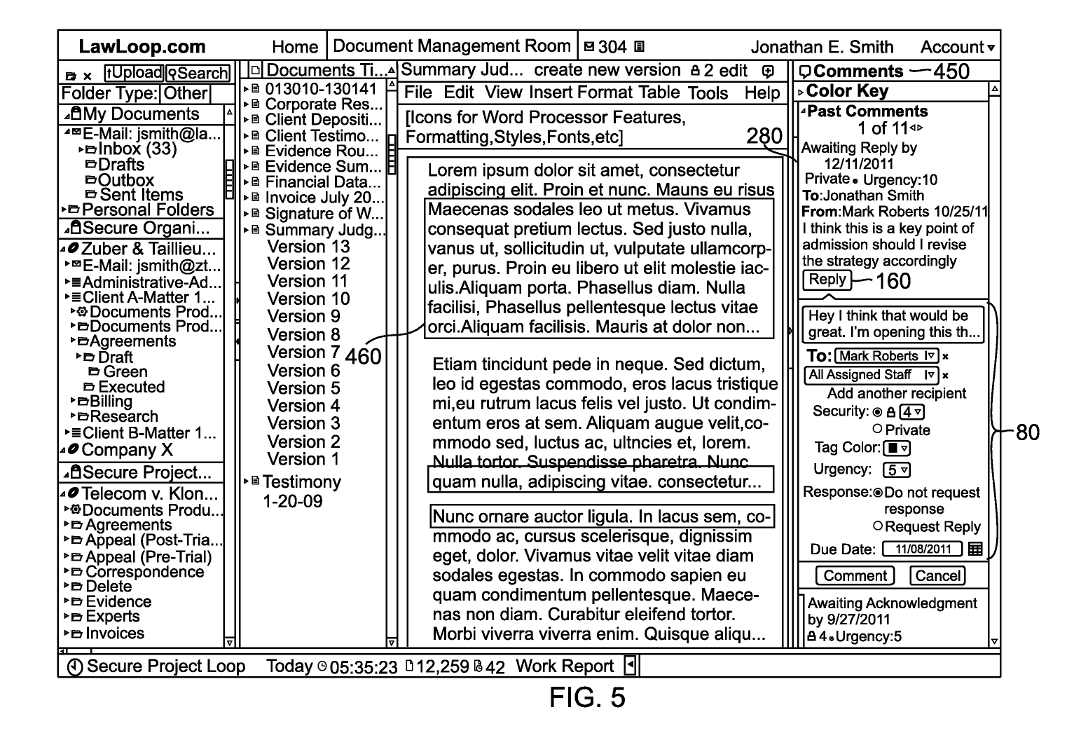

When the second member receives a notification of a comment on his profile home page (as shown at 60 in FIG. 1) the user can open the comment notification by clicking on it. By clicking on the notification the user clicks through to a web page that contains the associated document in the document management system, with the full text of the comment appearing adjacent to the document in a right-hand sidebar (as shown at 280 in FIG. 5). The second member can then respond to the comment with a reply directed to the first member (as shown at 80 in FIG. 5). Alternatively, the second member may create a new comment or question attached to the document by clicking the “Comments” bar which would expand the section intended for new comments (as shown at 450 in FIG. 5), and may address it to any member or members that belong to the network. In sum, any member of the network may create a comment attached to any document in the document management system, and may address the comment to any other member of the network.

After a member has sent a response to a comment, the notification of the original comment is automatically removed from the user's home page.

FIG. 1 is a view of a member's home page from which a member (as shown at 10 in FIG. 1) may choose to initiate one or more social networking functions, word processing applications, spreadsheet applications of the document management system in the Document Management Room (“DMR”) (as shown at 20 in FIG. 1). Also from this home page the member may choose initiate billing, accounting and invoicing applications of the financial management tool in the Financial Management Room (“FMR”) (as shown at 30 in FIG. 1). Additional social networking functionalities relating to communications options also exist in the context of this invention. From the member's home page, the member may also view notifications of comments pertaining to items (e.g.: documents) in the document management system (as shown at 40 in FIG. 1), and notifications of comments pertaining to items (e.g.: financial records) in the financial management tool (as shown at 50 in FIG. 1). In the preferred embodiment a comment notification consists of a due date, if one is assigned by the user (as shown at 370 in FIG. 1), a title, which is the name of the item being referenced (as shown at 60 in FIG. 1), the name of the user who sent the comment request or who is replying to a prior comment request (as shown at 350 in FIG. 1) and the comment itself in a truncated format (as shown at 360 in FIG. 1). The notification is linked to the item such that when the member opens the notification of a comment by clicking on the title or truncated comment portions of the notification, this command immediately opens the referenced item (i.e.: a word processing document, an account summary, an invoice, chart, spreadsheet, presentation or an image file like a PDF, PNG, GIF, TIFF or JPG) in its native location, like in the document management system or the financial management tool and simultaneously opens a comment sidebar on the same screen, thus allowing the user to immediately witness the referenced item (as shown at 460 in FIG. 5) together and alongside the comment presented in its entirety (as shown at 280 in FIG. 5). If the user should click on the comment request sender's name then the user is taken to the comment request sender's social network profile page. The truncated comment portion of the notification (as shown at 360 in FIG. 1) is the initial 70 characters, not counting spaces, of the complete original comment request followed by an ellipsis. An alternative embodiment may see the character count that comprises the truncated comment portion of a notification vary in number. The truncated comment found on the user's home page may itself be color coded with the color that the user chooses to tag the comment request with as well. One of skill in the art would understand that the details of the notifications appearing on the home page are not limited to those specifically mentioned here.

FIG. 2 shows one embodiment of a graphical user interface for the document management system accessible through the secure social network. A member wishing to add a comment to an item (as shown at 140 in FIG. 2) in the document management system may enter such comment in the “New Comment” field (as shown at 80 in FIG. 2) of the comment sidebar. In addition to creating a comment to be attached to an item, the member may also select a recipient, or recipients via the drop-down field at (as shown at 90 in FIG. 2), which lists of all members of the network. By selecting a recipient the user initiates an automatic notification of the comment which is sent by feed to the recipient's home page once the submit “Comment” button is clicked (as shown at 130 in FIG. 2). If more than one recipient is selected, then each recipient would receive a notification of the comment on his or her home page. Alternatively, recipients could be selected via an autofill field (i.e.: a field which automatically begins to suggest and list possible contact names based on the character sequence the user enters as they type their desired contact's name). FIG. 2 also shows that the member creating a comment can select a security level (as shown at 100 in FIG. 2) by selecting a security level from a drop-down list of security levels, or by clicking the security option of “Private” (as shown at 250 in FIG. 2). Each profile is assigned a security level by the social network administrator (as shown at 240 in FIG. 1). If a security level is selected for the comment (as shown at 100 in FIG. 2), then only members having that security level, or a higher clearance, will be able to view the comment. This feature would be especially useful in the circumstances where the comment request is intended for a large group or the entire network membership but low security level members are not the target audience. If the security level of “Private” is selected (as shown at 250 in FIG. 2), then only the selected recipient(s) will be able to view the comment, but other members viewing the document in the DMR would not be able to see the comment.

When creating a comment, the member may also select an urgency level by selecting an urgency level from a drop-down list of urgency levels (as shown at 110 in FIG. 2). The urgency level will control where the notification of comment appears in the queue on the receiving member's profile. If no urgency level is selected then the comment notifications will typically appear in the receiving member's feed queue in chronological order. For example, if a member selects the most urgent level for a comment request, the comment will post at the top of the receiving member's comment notifications feed on their home page if no other highest urgency level comment request exists (as shown at 60 in FIG. 1). If other comment requests have also been assigned with the highest urgency level then these comments will typically appear in the receiving member's queue in chronological order at the top of their comment notifications feed. If a member sends a comment request with a low urgency level or an urgency level lower than the highest possible level that comment will typically display in the receiving member's feed after a comment or group of comments that have higher urgency levels.

When creating a comment, the member may also select a response requirement by clicking a button in front of one of the “Response” options to indicate whether a response to the comment is necessary, or not (as shown at 120 in FIG. 2). The member may also select to include a “Due Date” to notify the recipient(s) of a time constraint associated with the comment request (as shown at 470 in FIG. 2). The user may enter a due date manually in the due date field or select a date from a calendar by clicking on the calendar icon.

Additional embodiments associated with the invention will include the same comment sidebar integrated within a document management system so that information and comments may be attached to word processing documents, spreadsheets, and images, as the member chooses. The due date itself may also be hour and minute (perhaps even specific to the second) specific in addition to date alone.

Integrated in the secure social networking system is a financial management tool. This tool includes a billing application used to track time worked by members of the network to bill clients for such work, bill clients for flat fee(s), contingency fee matters, and other tasks performed by billing software applications well known in the art, such as Prolaw®. The tool also includes an accounting application used to create invoices, and manage accounting of payments, debits and credits, etc. This financial management tool enables the members of the network to remotely manage the financial information relating to clients of members of the network, or clients of an entire organization comprised of members of the network.

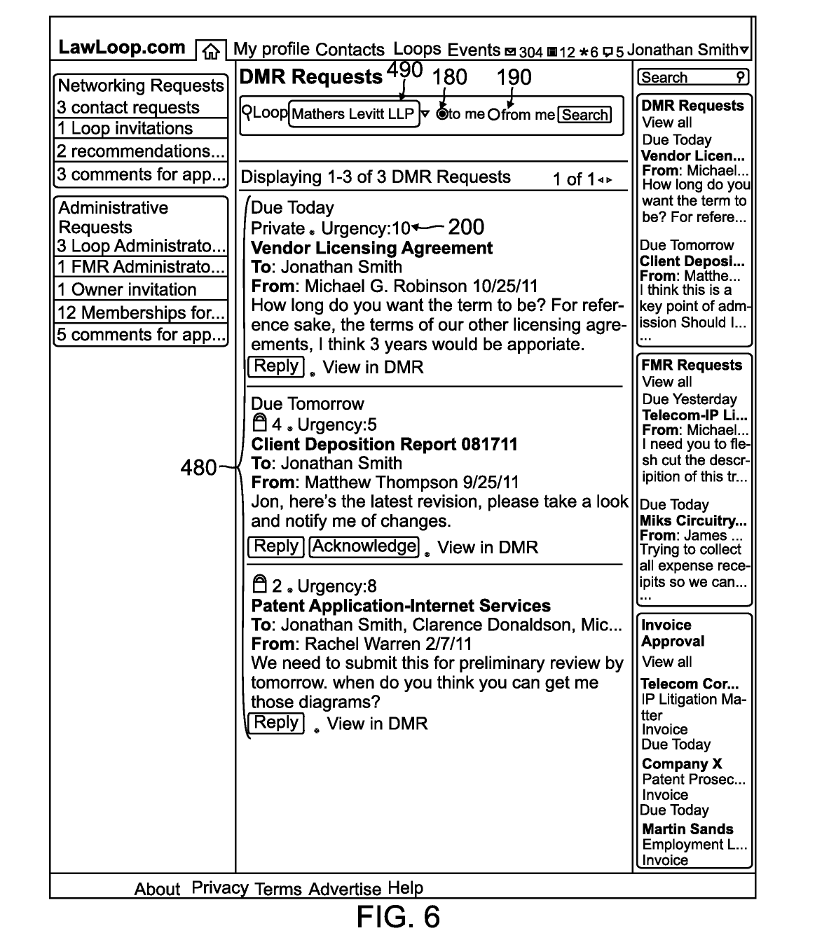

FIG. 3 shows an embodiment of a graphical user interface for a financial management tool in the context of a social networking community in accordance with the invention. A member wishing to add a comment to an item in the financial management tool may enter such comment in the “New Comment” section of the comment sidebar (as shown at 80 in FIG. 3). This commenting tool enables the members of the network to create a comment pertaining to a specific item opened in the financial management tool (as shown at 340 in FIG. 3). This comment, once created, remains attached to the specific item with which it is associated. All comments are archived along with the respective item they are attached to in a Past Comments section which can be reviewed in an abbreviated format when viewing the item (as shown at 110 in FIG. 3) or in their entirety if the user clicks through to a detailed comment request archive screen (as shown at 480 in FIG. 6). Using this tool, a member can create comments related to any item the member chooses in the financial management tool, such as a billing entry, an accounting application entry, or an invoice or a draft invoice.

In an alternative embodiment comments archived in the Past Comments section may be indented to signal to the user a conversation in either the FMR or the DMR (as shown at 410 in FIG. 10). A comment would be indented if the comment is a reply to a previous comment request.

The comment can be addressed to a second member of the network, and the second member will then receive a notification of the comment entered in the financial management tool via a feed to the home page of the second member's profile.

When the second member receives a notification of a comment on their profile home page the user can open the comment notification by clicking on it, and by doing so simultaneously opens the attached item in its native application, with the full text of the comment appearing adjacent to the item in the comment sidebar. The second member can then respond to the comment with his own new comment directed to the first member. Alternatively, the second member may create a new comment or question attached to the item, and may address it to any member of the network. In sum, any member of the network may create a comment attached to any item in the financial management tool, and may address the comment to any other member of the network. After a member has sent a response to a comment request, the notification of the original comment is automatically removed from his home page. In an alternative embodiment the action of opening a comment notification and/or acknowledging its receipt may automatically qualify the comment notification from appearing in a comment notification feed.

In an alternative embodiment the comment notification feed or feeds may appear in a page or pages other than the home page. For example a notification feed may be included on the first page that is presented to the member in the DMR after the user clicks the DMR button on the home page (as shown at 20 in FIG. 1) or the first page that is presented to the member after the user clicks on the FMR button on the home page (as shown at 30 in FIG. 1).

As an example, if the member Jonathan were to add a comment to an item in the financial management tool, Jonathan would compose the comment in the “New Comment” section (as shown at 80 in FIG. 3). If Jonathan wanted another member named Mr. Marshall to be able to receive a notification of the comment, Jonathan would do so by selecting Marshall's name from the drop-down list provided in the “TO:” field (as shown at 90 in FIG. 3), or entering the name manually. If Jonathan wanted only Mr. Marshall to be able to view the comment, Jonathan would select the security level “Private” (as shown at 250 in FIG. 3) so that only Marshall would be able to view the comment. To signal to Mr. Marshall what this comment request may regard, Jonathan may pick a “Tag Color” to associate with the comment (as shown at 300 in FIG. 3). To indicate the urgency with which the recipient should respond and for purposes of ranking the comment in the recipient's queue, Jonathan would select an urgency level (as shown at 110 in FIG. 3). To indicate whether a response to his comment is necessary, Jonathan would select from a list of options indicating whether or not a reply or acknowledgement is needed (as shown at 120 in FIG. 3). To indicate that the comment request is time sensitive Jonathan would designate a due date (as shown at 470 in FIG. 3). Having had selected a “Tag Color” (as shown at 300 in FIG. 3) Jonathan might also want to highlight the area of the item to which he is referring in his comment (as shown at 430 in FIG. 3). After Jonathan has created the comment and selected the recipient, security, urgency, response, tag color and due date options described above, Jonathan would then click on the “Comment” button (as shown at 130 in FIG. 3), which would attach the comment to the item, and automatically post a notification of the comment to Marshall's home page.

After a first member has created a comment, a notification of the comment is sent to all members who have been selected as recipients. A second member who has been selected as a recipient will receive a notification of the comment via a feed to the second member's profile (as shown at 40 and 50 in FIG. 1). The second member may then open the notification of the comment by clicking on the notification itself. When the second member opens the notification of a comment by clicking on the notification, this command immediately opens the referenced item (e.g.: a word processing document, an account summary, an invoice, chart, spreadsheet, presentation or an image file like a PDF, PNG, GIF, TIFF or JPG) in the item's native application, and simultaneously presents a comment sidebar alongside the referenced item on the same screen, thus allowing the second member to immediately view the referenced item together with the complete comment (as shown at 280 in FIG. 4). The second member can then reply to the first user's comment in the comment sidebar by clicking the reply button (as shown at 160 in FIG. 4), entering the text of their reply in a text field (as shown at 70 in FIG. 4), determining the security level (as shown at 100 in FIG. 4), choosing a tag color (as shown at 300 in FIG. 4), selecting a level of urgency from a drop-down field (as shown at 110 in FIG. 4) or whether it's a private comment (as shown at 250 in FIG. 4), selecting a response action for the recipient (as shown at 120 in FIG. 4), setting a due date if necessary (as shown at 470 in FIG. 4) and clicking the comment button (as shown at 130 in FIG. 4) to send a notification of the reply to the first member's home page.

Using a similar process, the second member could initiate the process of responding to each of the notifications in the DMR notifications feed (as shown 40 in FIG. 1), and FMR notifications feed (as shown at 50 in FIG. 1).

An alternative embodiment would prefill or auto-select many of the reply request settings to match those of the original sender's request settings. For example, if the first user sends a request to the second user with a security level of 4, which is not private, but has an urgency level of 5 and requests a response, then if and when the second user replies to the first user's request not only is the To field prefilled with the first user's name (as shown at 90 in FIG. 4) but so are the security level settings, which would be set at 4 (as shown at 100 in FIG. 4), the urgency level, which would be set at 5 (as shown at 110 in FIG. 4) and the response request action, which would be set at Do not request response (as shown at 120 in FIG. 4). If a user has been associated with a tag color then by default their corresponding tag color is pre-selected for the user (as shown at 300 in FIG. 4). In this manner the second user can expedite the process of replying to a request from the first user as he would only have to enter text in a text field (as shown at 70 in FIG. 4) and click the comment button to send his reply (as shown at 130 in FIG. 4). The second user is free to alter any of the prefilled or auto-selected settings at any time prior to sending the reply.

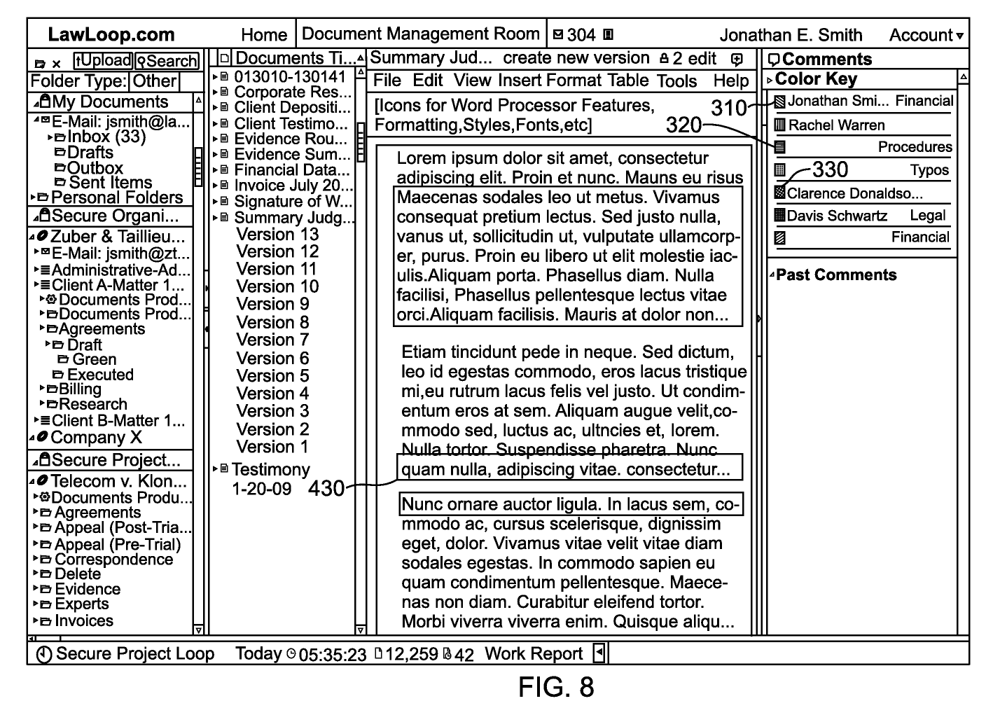

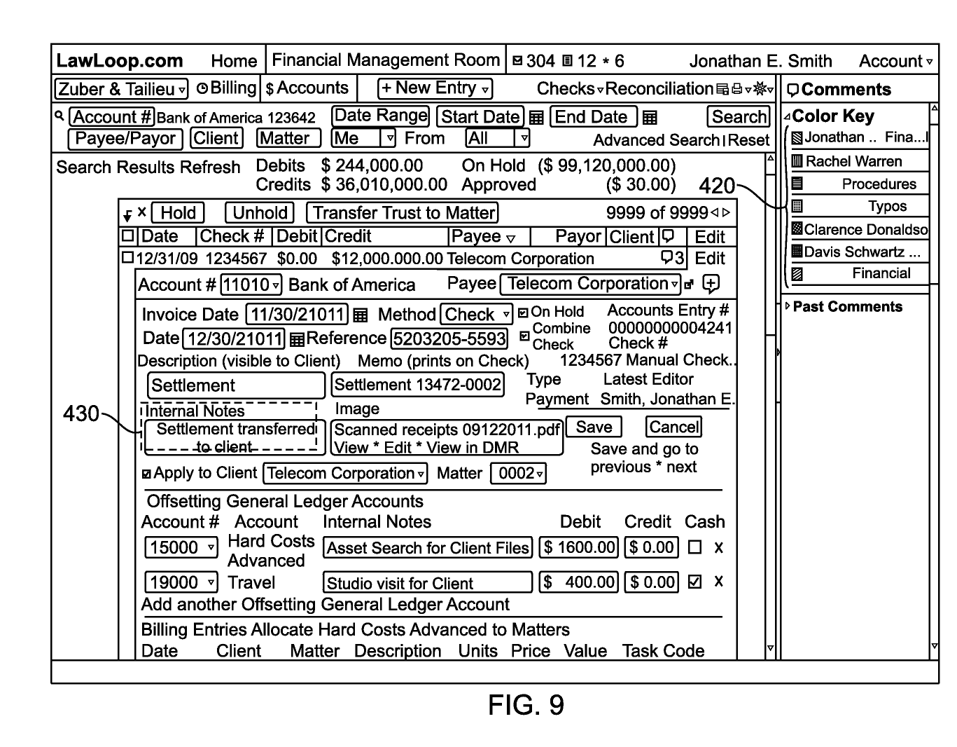

The comment requests which appear in the DMR and FMR may be color coded, as follows: a member may select a color to be associated with a specific member within the context of an individual matter, such that all comments attached to a document or item in that particular matter will appear in a font of the selected tag color or in association with the selected color as defined by members in the corresponding color key (as shown at 420 in FIG. 9). Members of a network assign color codes to their requests (as shown at 300 in FIG. 2). Color codes may be decided by any of the members in a network. Color codes can be understood to represent a specific network member within the context of a matter (as shown at 330 in FIG. 8), a category within the context of a matter, for example a category regarding Procedures (as shown at 320 in FIG. 8) and a combination of the two within the context of a matter, meaning a member who is also associated with a category, for example member Jonathan Smith is also associated with the financial category (as shown at 310 in FIG. 8). While the aforementioned color coding example was set in the context of the DMR (as shown in FIG. 8) the same functionality exists within the context of the FMR (as shown at 420 in FIG. 9). Ultimately it is up to the members of the network to define what tag color codes mean as a color could represent any number of things within the context of any given matter.

In the preferred embodiment the comment request color key is applicable at the matter level in the DMR. In other words a color key is unique to every matter as it is likely that different matters may consistently involve different parties and may need to serve not only different people but also different needs which may be unique to any given matter. By default the color key in the DMR will be set to define basic ideas like a series of colors used to establish an order or scale of importance. For example the color red would signal a comment of the most importance, the color orange would signal a comment of secondary importance, the color purple may signal a typo and the a blue color could signal an area that needs further development. By default the color key in the FMR will be set to define basic accounting ideas. For example the color red would signal an accounting error, the color yellow may signal a questionable entry or transaction, the color green may signal a corrected figure. Like in the DMR a color may be established to represent not just an individual but also a category, like a comment regarding invoicing or payroll. When defining tag colors in the color key a member may include as many or as few colors in the color key as is needed for any given matter in the DMR or accounting record in the FMR. Any member that can access a matter or financial record may view, reference and edit the color key which can be found in its own section between the area where the user creates new comments and where past comments are listed in the DMR (as shown at 380 in FIG. 10) and in the FMR (as shown at 380 in FIG. 3). In addition to being able to view a comment next to the referenced file in the DMR or a financial record in the FMR the color with which the comment is tagged can be used directly on either type of file. In other words a user can highlight, with a user selected tag color (as shown at 300 in FIG. 3), the area to which the user is referring to in their comment (as shown at 430 in FIG. 3). The user may highlight any part of an open file in the DMR or FMR with a transparent color box by choosing a color when creating a new comment request. To highlight a section in an open file the user may click and hold down the mouse button, or whichever device the user uses to manipulate the cursor, as they drag the cursor to highlight the desired area at which point the user lets the button go to complete the highlighting process (as shown at 430 in FIG. 3). The highlighting process can be initiated at any point during the creation of a new comment so long as the user has selected a tag color, (as shown at 300 in FIG. 3) and the user has not yet posted their comment request by clicking the submit comment button (as shown at 130 in FIG. 3). When referencing a comment the user may mouse over the highlighted area which would reveal a box that contains information that regards the commentator and when the comment was posted, (as shown at 400 in FIG. 10). This commentator box would be associated with the same tag color as the comment was (as shown at 440 in FIG. 10). The information in the commentator box would list basic profile information regarding the commentator such their profile picture, name and title in addition to the date and hour the comment request was posted.

In an alternative embodiment the highlighting process may not render a transparent color box that covers the area that the user is commenting on but may instead distinguish the area that is being referenced by changing the appearance of the content to match the tag color. For example, the color of the highlighted text may be changed and underlined to match the selected comment tag color (as shown at 390 in FIG. 10).

A user may view all of the Document Management Room (“DMR”) Requests (as shown at 40 in FIG. 1), by clicking on the “View All” hotlink (as shown at 270 in FIG. 1). By doing so the user will then click through to a detailed view of the DMR notification feed (shown at 480 in FIG. 6). The user may then select to view either comment response requests and reply response requests sent to the user from other members (shown at 180 in FIG. 6), or comment response requests and reply response requests sent by the user to other members (shown at 190 in FIG. 6). The results the user views are always within the context of a selected matter, which the user is free to choose from a drop-down list (as shown at 490 in FIG. 6).

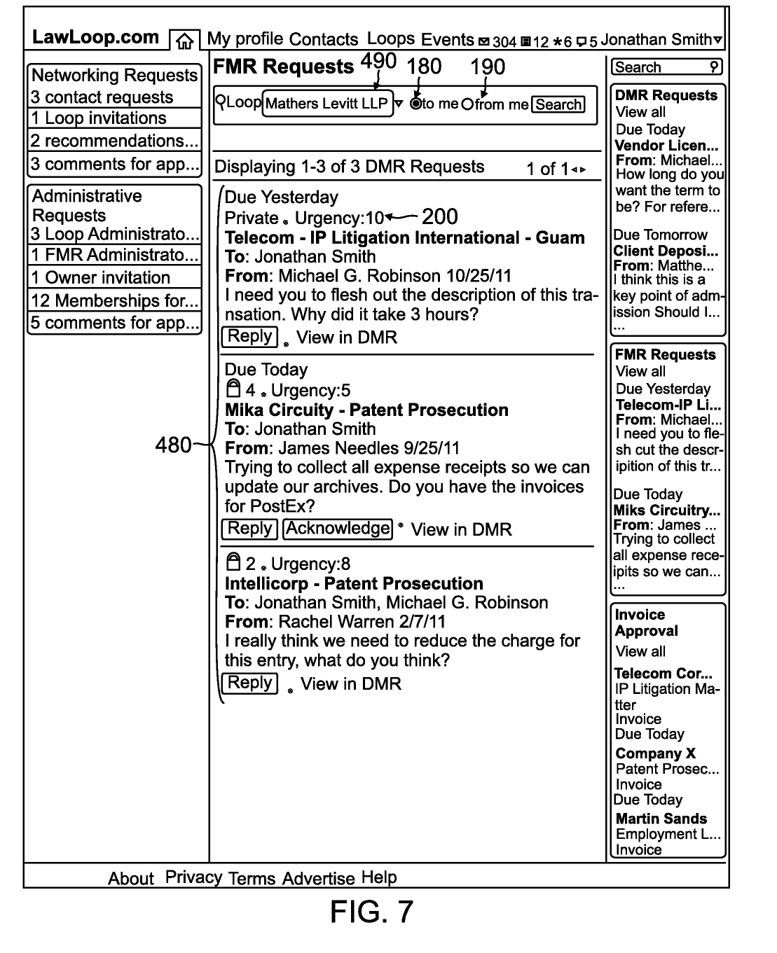

A user may view all of the Financial Management Room (“FMR”) Requests (as shown at 50 in FIG. 1), by clicking on the “View All” hotlink (as shown at 290 in FIG. 1). By doing so the user will then click through to a detailed view of the FMR notification feed (shown at 480 in FIG. 7). The user may then select to view either comment response requests sent to the user from other members (shown at 180 in FIG. 7), or requests sent by the user to other members (shown at 190 in FIG. 7). The results the user views are always within the context of a selected matter, which the user is free to choose from a drop-down list (as shown at 490 in FIG. 7).

Although this embodiment describes the ability to attach a comment to a word processing document, the invention is also intended to be used in connection with other commonly used office programs such as spreadsheet programs, image editing programs, or presentation programs. Likewise the invention may be adapted to be used with specialized software or programs used by professionals, service providers or groups and associations that require a collaborative environment in which to exchange information, ideas, data and comments. An example of such a specialized program might be a computer aided drafting system used by engineers or architects who need to collaborate to develop a project. Perhaps another specialized application of the invention might be an online virtual classroom where students may work collaboratively on a document or project.

By integrating a commenting tool with document creation and document management applications, the invention promotes efficiency in communicating. As contemplated by the invention, the member is able to see notifications of all comments sent to him by other members on his home page via a comment request notifications feed or feeds. By opening a comment notification the user simultaneously opens the attached document in its native application. Unlike email applications, the member never needs to open a separate attachment. When viewing or working on a document in the document management system or a financial record in the financial management system, the member can add a comment and send the comment to another member, or members, without having to attach the document as is required when sending documents by email. Furthermore, the member can highlight what they are referencing on the actual item that they commenting on itself. All comments are always attached to the document, file or item they are associated with. Clicking on a comment notification always results in the associated document, file or item opening in its native application with the comment in its entirety presented alongside the file in question.

Furthermore, by employing this integrated commenting tool, the member can be sure that other members to whom his comments are directed will immediately and securely be able to view the referenced document and the comment on the same screen simultaneously.

It is to be understood that other embodiments may be utilized and functional changes may be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings.

1. A computer-implemented method for interactive collaboration within a secure online social networking system, comprising:
providing a secure, cloud computing-based social network system, comprising:
a plurality of member virtual identities forming an online community of members, each of the member virtual identities associated with a member profile, which profile is enabled with a plurality of social networking functionalities and associated with a profile page;
a network of member virtual identities that excludes at least one member virtual identity of the community, wherein member virtual identities belonging to the network share access to financial information in a secured remote environment, such that member virtual identities not belonging to the network do not have access to the financial information;
a financial management tool module comprised of at least one application selected from the group consisting of a billing application, an accounting application, and an invoicing application, wherein the financial management tool enables the members of the network to remotely manage the financial information; and
a commenting tool module that enables a first member of the network to associate a comment with an item associated with an application of the financial management tool module, wherein the comment is addressable to a second member of the network, and
the system is configured to post a notification of the comment on a profile page of the second member.

2. The method of claim 1, wherein the profile page of the second member has a home page and the notification of the comment is posted on said home page.

3. The method of claim 1, wherein the comment can be made private such that at least one member of the network does not have authorized access to the comment.

4. The method of claim 1, wherein the comment can be assigned a security level, such that only members of the network assigned that security level or a higher security level have authorized access to the comment.

5. The method of claim 1, wherein the notification of the comments includes a link to the comment.

6. The method of claim 1, wherein the notification includes a link to the comment, and the comment and the item appear on the same page.

7. The method of claim 1, wherein the system is configured second member can respond to the comment to cause the notification to disappear from the page.

8. The method of claim 1, wherein the item is associated with a matter, the comment visually references a color, and the color is associated with the first member, and at least one other comment associated with an item associated with the matter visually references the color.

9. The method of claim 1, wherein the item is associated with a matter, the comment visually references a color, and the color is associated with the first member, at least one other comment associated with an item associated with the matter visually references the color, and the first member is associated with a different color visually referenced by a comment associated with an item associated with a different matter.

10. The method of claim 1, wherein the second member also receives social networking notifications on the page.

11. A computer-implemented method for interactive collaboration within a secure online social networking system, comprising:
providing a secure, cloud computing-based social network system, comprising:
a plurality of member virtual identities forming an online community of members, each of the member virtual identities associated with a member profile, which profile is enabled with a plurality of social networking functionalities and associated with a profile page;
a network of member virtual identities that excludes at least one member virtual identity of the community, wherein member virtual identities belonging to the network share access to documents in a secured remote environment, such that member virtual identities not belonging to the network do not have access to the documents;
a document management tool module comprised of at least one application selected from the group consisting of an email application, word processor application, a spreadsheet application, a presentations application, and an images application, wherein the document management tool module enables the members of the network to remotely manage the documents; and
a commenting tool module that enables a first member of the network to associate a comment with a document, wherein the comment is addressable to a second member of the network, and
the system is configured to post a notification of the comment on a profile page of the second member.

12. The method of claim 11, wherein the page is the home page of the second member's profile.

13. The method of claim 11, wherein said comment can be made private such that at least one member of said network does not have authorized access to said comment.

14. The method of claim 11, wherein said comment can be assigned a security level, such that only members of said network assigned that security level or a higher security level have authorized access to said comment.

15. The method of claim 11, wherein said notification includes a link to said comment.

16. The method of claim 11, wherein the notification includes a link to the comment, and the comment and the financial management tool item appear on the same page.

17. The method of claim 11, wherein the second member can respond to the comment to cause the notification to disappear from the page.

18. The method of claim 11, wherein the item is associated with a matter, the comment visually references a color, and the color is associated with the first member, and at least one other comment associated with an item associated with the matter visually references the color.

19. The method of claim 11, wherein the item is associated with a matter, the comment visually references a color, and the color is associated with the first member, at least one other comment associated with an item associated with the matter visually references the color, and the first member is associated with a different color visually referenced by a comment associated with an item associated with a different matter.

20. The method of claim 11, wherein the system is also configured to post social networking notifications to the second member on the page.

21. A computer-implemented method for interactive collaboration within a secure online social networking system, comprising:
providing a secure, cloud computing-based social network system, comprising:
a plurality of member virtual identities forming an online community of members, each of the member virtual identities associated with a member profile, which profile is enabled with a plurality of social networking functionalities and associated with a profile page;
a network of member virtual identities that excludes at least one member virtual identity of the community, wherein member virtual identities belonging to the network share access to documents and financial information in a secured remote environment, such that member virtual identities not belonging to the network do not have access to the documents or the financial information;
a document management tool module comprised of at least one application selected from the group consisting of an email application, a word processor application, a spreadsheet application, a presentations application, and an images application, wherein the document management tool module enables the members of the network to remotely manage the documents;
a financial management tool module comprised of at least one application selected from the group consisting of a billing application, an accounting application, and an invoicing application, wherein the financial management tool module enables the members of the network to remotely manage the financial information; and a commenting tool module that enables a first member of the network to associate a comment with a document or a financial management tool item, wherein the comment is addressable to a second member of the network, and the system is configured to post a notification of the comment on a profile page of the second member.

22. The method of claim 21, wherein the page is the home page of the second member's profile.

23. The method of claim 21, wherein said comment can be made private such that at least one member of said network does not have authorized access to said comment.

24. The method of claim 21, wherein said comment can be assigned a security level, such that only members of said network assigned that security level or a higher security level have authorized access to said comment.

25. The method of claim 21, wherein said notification includes a link to said comment.

26. The method of claim 21, wherein the notification includes a link to the comment, and the comment and the financial management tool item appear on the same page.

27. The method of claim 21, wherein the second member can respond to the comment to cause the notification to disappear from the page.

28. The method of claim 21, wherein the document or item is associated with a matter, the comment visually references a color, and the color is associated with the first member, and at least one other comment associated with a document or item associated with the matter visually references the color.

29. The method of claim 21, wherein the document or item is associated with a matter, the comment visually references a color, and the color is associated with the first member, at least one other comment associated with an item associated with the matter visually references the color, and the first member is associated with a different color visually referenced by a comment associated with a document or item associated with a different matter.

30. The method of claim 21, wherein the system is further configured to post social networking notifications to the second member on the page.
